(19) United States
(12) Patent Application Publication
(10) Pub. No.: US 2015/0343614 A1
(43) Pub. Date: Dec. 3, 2015

(54) Spark Plug Tool Device

(71) Applicant: Ben Hassler, Ferndale, WA (US)

(72) Inventor: Ben Hassler, Ferndale, WA (US)

(21) Appl. No.: 14/292,108

(22) Filed: May 30, 2014

(51) Int. Cl. B25B 13/48; B25G 1/02; B25G 1/06; B25B 13/06

(52) U.S. Cl. CPC B25B 13/483; B25B 13/06; B25G 1/025; B25G 1/066

(57) ABSTRACT

A spark plug tool device loosens and tightens a spark plug. The device includes a tubular member having a first end, a second end and a perimeter wall attached to and extending between the first end and the second end. A socket extends into the first end of the tubular member and receives a spark plug therein for loosening and tightening the spark plug. A neck is coupled to and extends from the second end of the tubular member. A handle is coupled to a distal end of the neck with respect to the tubular member. A breaker bar is coupled to the handle.

### BACKGROUND OF THE DISCLOSURE

### Field of the Disclosure

The disclosure relates to tool devices and more particularly pertains to a new tool device for loosening or tightening a spark plug.

### SUMMARY OF THE DISCLOSURE

An embodiment of the disclosure meets the needs presented above by generally comprising a tubular member having a first end, a second end and a perimeter wall attached to and extending between the first end and the second end. A socket extends into the first end of the tubular member. The socket receives a spark plug therein for loosening and tightening the spark plug. A neck is coupled to and extends from the second end of the tubular member. A handle is coupled to a distal end of the neck with respect to the tubular member. A breaker bar is coupled to the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a spark plug tool device according to an embodiment of the disclosure.

FIG. 2 is a side view of an embodiment of the disclosure.

FIG. 3 is a cross-sectional view of an embodiment of the disclosure taken along line 3-3 of FIG. 2.

FIG. 4 is an in-use side view of an embodiment of the disclosure.

### DESCRIPTION OF THE PREFERRED EMBODIMENT

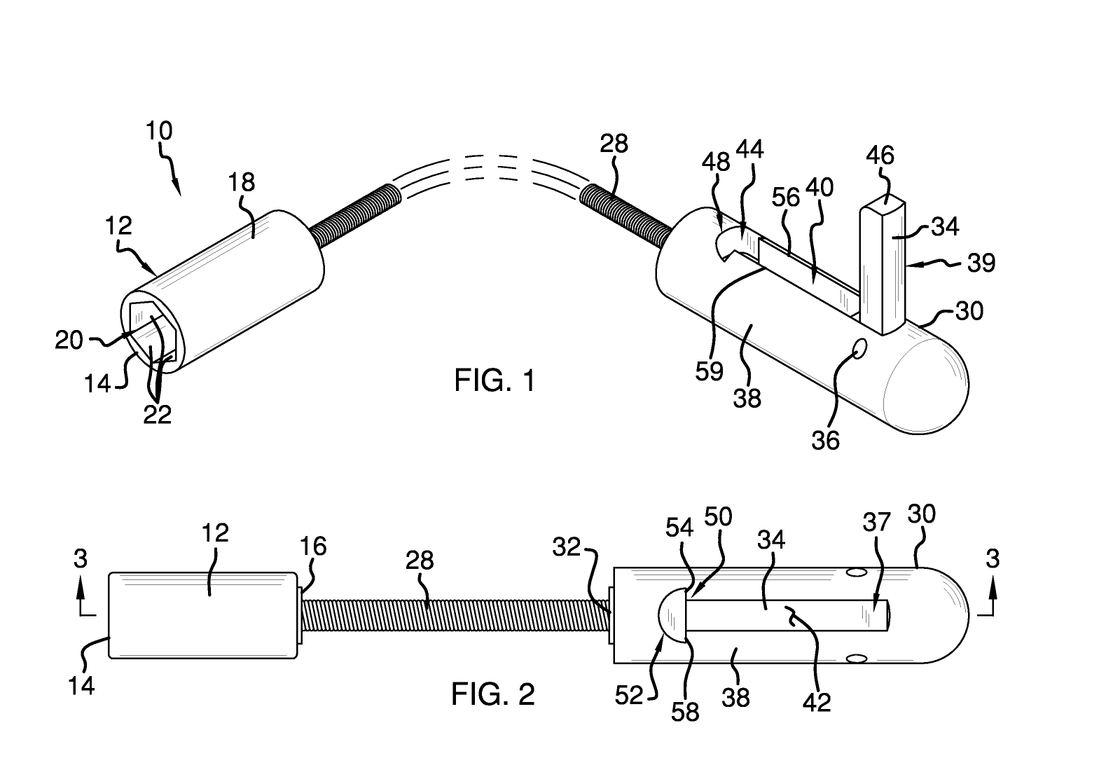

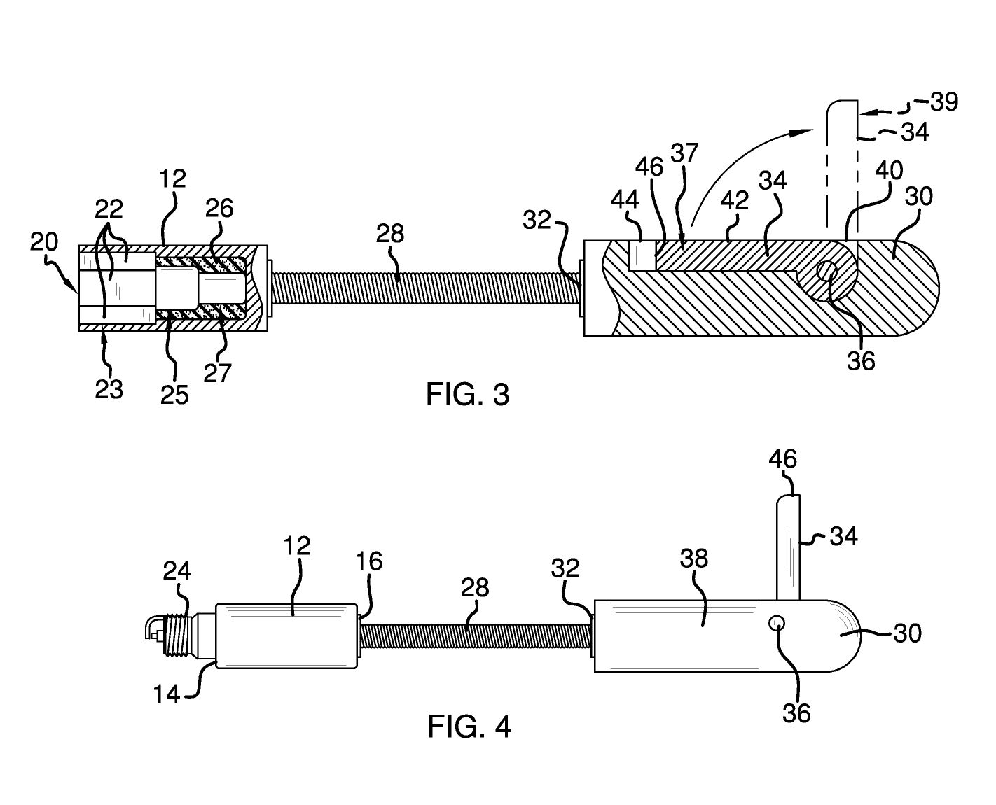

With reference now to the drawings, and in particular to FIGS. 1 through 4 thereof, a new tool device embodying the principles and concepts of an embodiment of the disclosure and generally designated by the reference numeral 10 will be described.

As best illustrated in FIGS. 1 through 4, the spark plug tool device 10 generally comprises a tubular member 12 having a first end 14, a second end 16 and a perimeter wall 18 attached to and extending between the first end 14 and the second end 16. A socket 20 extends into the first end 14 of the tubular member 12. The socket 20 may include a first section 23, a second section 25 and a third section 27 wherein the second section 25 is positioned between and coupled to each of the first 23 and third 27 sections. The first section 23 is defined by a plurality of planar faces 22 extending into and positioned adjacent to the first end 14 of the tubular member 12. The third section 27 has a smaller outer diameter than the second section 25. Each of the second 25 and third 27 sections may be cylindrically-shaped. The socket 20 is configured to receive a spark plug 24 therein for either loosening or tightening of the spark plug 24. A grommet 26 may be coupled to and positioned in the socket 20 wherein the grommet 26 is configured to engage the spark plug 24. The grommet 26 may be constructed from an elastomeric material, such as rubber or the like, to ensure that the spark plug 24 is securely retained in the socket 20 when the spark plug 24 is inserted into the socket 20.

A neck 28 is coupled to and extends from the second end 16 of the tubular member 12. A handle 30 is coupled to a distal end 32 of the neck 28 with respect to the tubular member 12. The neck 28 is flexible to permit selective positioning of the tubular member 12 relative to the handle 30. The handle 30 may be comprised of an elastomeric material, such as rubber or the like to allow a user to comfortably grip the handle 30. A breaker bar 34 is coupled to the handle 30 and is pivotable relative to the handle 30. This may be accomplished by having a pin 36 coupled to the handle 30 that extends through the breaker bar 34 and allows the breaker bar 34 to pivot about the pin 36 between a stored position 37 and a deployed position 39. A peripheral wall 38 of the handle 30 has a slot 40 extending therein for receiving the breaker bar 34 when the breaker bar 34 is in the stored position 37. A top side 42 of the breaker bar 34 may be positioned flush with respect to the peripheral wall 38 of the handle 30 when the breaker bar 34 is in the stored position 37.

The handle 30 may have a recess 44 extending therein. The recess 44 intersects the slot 40 and is positioned adjacent to a free end 46 of the breaker bar 34 when the breaker bar 34 is positioned in the stored position 37 wherein the recess 44 is configured to receive a finger of a user therein when the user is pivoting the breaker bar 34 into and out of the slot 40. The recess 44 has a perimeter edge 48 including a top section 50 coupled to a bottom section 52. The top section 50 includes a first segment 54 coupled to and extending outwardly from a first longitudinal side 56 of the slot 40 and a second segment 58 coupled to and extending outwardly from a second longitudinal side 59 of the slot 40. The first segment 54 and the second segment 58 extend outwardly away from each other in opposite directions with respect to each other and may be positioned transverse relative to the first 56 and second 59 longitudinal sides of the slot 40. The bottom section 52 is positioned distally relative to the slot 40 and may be arcuate.

In use, a spark plug 24 on a vehicle is inserted into the socket 20 so that the grommet 26 engages the spark plug 24. A tool, such as a wrench or a ratchet, may then used to engage the tubular member 12 to allow the spark plug 24 to be rotated by the tool for either tightening or loosening of the spark plug 24. For removal of the spark plug 24 from the vehicle, the breaker bar 34 may be pivoted out of the slot 40 and used in a conventional manner to apply torque to remove the spark plug 24 from the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A spark plug tool device comprising:
a tubular member having a first end, a second end and a perimeter wall attached to and extending between said first end and said second end;
a socket extending into said first end of said tubular member and being configured to receive a spark plug therein for loosening and tightening of the spark plug;
a neck coupled to and extending from said second end of said tubular member;
a handle coupled to a distal end of said neck with respect to said tubular member; and
a breaker bar coupled to said handle.

2. The device of claim 1, further comprising said neck being flexible to permit selective positioning of said tubular member relative to said handle.

3. The device of claim 1, further comprising a grommet coupled to and positioned in said socket wherein said grommet is configured to engage the spark plug.

4. The device of claim 1, further comprising said breaker bar being pivotable relative to said handle wherein said handle is pivotable between a stored position and a deployed position.

5. The device of claim 4, further comprising a pin coupled to said handle, said pin extending through said breaker bar and allowing said breaker bar to pivot about said pin between the stored position and the deployed position.

6. The device of claim 4, further comprising wherein said handle includes a peripheral wall, said peripheral wall having a slot extending therein for receiving said breaker bar when said breaker bar is in the stored position.

7. The device of claim 6, further comprising a top side of said breaker bar being positioned flush with respect to said peripheral wall of said handle when said breaker bar is in the stored position.

8. The device of claim 6, further comprising wherein said handle includes a recess extending therein, said recess intersecting said slot and being positioned adjacent to a free end of said breaker bar when said breaker bar is positioned in the stored position wherein said recess is configured to receive a finger of a user therein when the user is pivoting said breaker bar into and out of said slot.

9. The device of claim 8, further comprising wherein said recess has a perimeter edge including a top section coupled to a bottom section, said top section including a first segment coupled to and extending outwardly from a first longitudinal side of said slot and a second segment coupled to and extending outwardly from a second longitudinal side of said slot, said first segment and said second segment extending outwardly away from each other in opposite directions with respect to each other.

10. The device of claim 9, further comprising wherein said bottom section is arcuate and positioned distally relative to said slot.

11. The device of claim 1, further comprising said handle being comprised of an elastomeric material.

12. The device of claim 1, further comprising said socket including a first section, a second section and a third section wherein said second section is positioned between and coupled to each of said first and third sections, said first section being defined by a plurality of planar faces extending into and positioned adjacent to said first end of said tubular member, said third section having a smaller outer diameter than said second section.

13. The device of claim 12, further comprising each of said second and third sections of said socket being cylindrically-shaped.

14. A spark plug tool device comprising:
a tubular member having a first end, a second end and a perimeter wall attached to and extending between said first end and said second end;
a socket extending into said first end of said tubular member and being configured to receive a spark plug therein for loosening and tightening of the spark plug, said socket including a first section, a second section and a third section wherein said second section is positioned between and coupled to each of said first and third sections, said first section being defined by a plurality of planar faces extending into and positioned adjacent to said first end of said tubular member, said third section having a smaller outer diameter than said second section, each of said second and third sections of said socket being cylindrically-shaped;
a grommet coupled to and positioned in said socket wherein said grommet is configured to engage the spark plug;
a neck coupled to and extending from said second end of said tubular member, said neck being flexible;
a handle coupled to a distal end of said neck with respect to said tubular member, said handle including a peripheral wall, said handle being comprised of an elastomeric material;
a breaker bar coupled to said handle, said breaker bar being pivotable relative to said handle between a stored position and a deployed position, said peripheral wall of said handle having a slot extending therein for receiving said breaker bar when said breaker bar is in the stored position, a top side of said breaker bar being positioned flush with respect to said peripheral wall of said handle when said breaker bar is in the stored position;
said handle including a recess extending therein, said recess intersecting said slot and being positioned adjacent to a free end of said breaker bar when said breaker bar is positioned in the storage position wherein said recess is configured to receive a finger of a user therein when the user is pivoting said breaker bar into and out of said slot, said recess having a perimeter edge including a top section coupled to a bottom section, said top section including a first segment coupled to and extending outwardly from a first longitudinal side of said slot and a second segment coupled to and extending outwardly from a second longitudinal side of said slot, said first segment and said second segment extending outwardly away from each other in opposite directions with respect to each other, said first and second segments being positioned transverse relative to said first and second longitudinal sides of said slot, said bottom section being arcuate and positioned distally relative to said slot; and
a pin coupled to said handle, said pin extending through said breaker bar and allowing said breaker bar to pivot about said pin.
